(19) United States
(12) Patent Application Publication
(10) Pub. No.: US 2015/0066239 A1
(43) Pub. Date: Mar. 5, 2015

(54) VEHICLE NETWORK MONITORING METHOD AND APPARATUS

(71) Applicant: Mitsuhiro Mabuchi, Shinagawa-ku (JP)

(72) Inventor: Mitsuhiro Mabuchi, Shinagawa-ku (JP)

(73) Assignee: TOYOTA JIDOSHA KABUSHIKI KAISHA, Toyota-shi (JP)

(21) Appl. No.: 14/367,554

(22) PCT Filed: Dec. 14, 2012
(86) PCT No.: PCT/IB12/02707

§ 371 Date: Jun. 20, 2014

(30) Foreign Application Priority Data
Dec. 21, 2011 (JP) 2011-279859

(51) Int. Cl. H04L 29/06

(52) U.S. Cl. CPC H04L 63/1458; H04L 63/1425
USPC 701/1

(57) ABSTRACT

A vehicle network is provided with a monitoring-purpose onboard control apparatus that detects illicit data through monitoring the data communication format predetermined in order to operate a communication protocol that is used in the vehicle network. Upon detecting illicit data whose communication format is different from the prescribed communication format, the monitoring-purpose onboard control apparatus performs a process of transmitting alarm information to onboard control apparatuses, and also performs a process of prohibiting gateways from routing the illicit data.

### BACKGROUND OF THE INVENTION

1. Field of the Invention

The invention relates to a vehicle network monitoring method and a vehicle network monitoring apparatus that monitor data transmitted to a vehicle network installed in a vehicle such as a motor vehicle and the like.

2. Description of Related Art

Vehicles, such as motor vehicles and the like, that are made in recent years are equipped with many onboard control apparatuses, including onboard control apparatuses that constitute a navigation system, onboard control apparatuses that electronically control various onboard appliances, such as an engine, a brake, etc., onboard control apparatuses that control such appliances as meters and the like that indicate various states of the vehicle, etc. Then, in such a vehicle, the various onboard control apparatuses are electrically connected by communication lines so that a vehicle network is formed, and the various onboard control apparatuses send or transmit various data to and receive various data from each other via the vehicle network.

Furthermore, it is required that such a vehicle network be provided with very high-level security since the various onboard control apparatuses connected to the vehicle network carry out the functions of controlling the various onboard appliances that are mounted in the vehicle, including the engine, the brake, etc. However, vehicle networks are primarily isolated from the external networks. Therefore, a vehicle network, for example, a controller area network (CAN) or the like, is designed on the precondition that the data transmitted and received in the vehicle network are authentic data that are transmitted from authentic onboard control apparatuses.

On another hand, lately, there are being developed systems that allow various data to be exchanged between a vehicle network as described above and an external network and also between a vehicle network of a vehicle and an external appliance that is connected to a data link connector (DLC) provided in that vehicle. In order to secure security of such a system, consideration is being given to introduction or adoption of an intrusion detection in which illicit or unauthorized access is detected by such a technique as an illicit event detection technique that performs signature matching with pre-registered data, an abnormality detection technique that detects as abnormality an operation or action that is different from usual ones, etc.

As an example, in a system described in Japanese Patent Application Publication No. 2003-264595 (JP 2003-264595 A), as shown in FIG. 11, a luring apparatus B1 that relays data communication is provided between an internal network B30 and an external network B20. The luring apparatus B1 includes a luring portion B3 that lures data suspected of illicit (or improper) access to a decoy network B40, a packet relay portion B2 made up of a filtering process portion B5 that filters data transmitted from the external network B20 and an intrusion detection portion B4 that detects attacks, such as so-called DoS attack (denial-of-service attack) of sending a large amount of illicit or improper data, etc. In the luring apparatus B1 constructed in this manner, when data transmitted from the external network B20 is received, the reliability of the data is then determined on the basis of a filtering table B6, and illicit (or improper or strange) data is discarded on the basis of the determined reliability, and data suspected of illicit access is lured to the decoy network B40. Then, the luring apparatus B1 transfers only data that is not suspected of illicit access, to the internal network B30. In this manner, illicit data and data suspected of illicit access are restrained from being input to the internal network B30.

Of the intrusion detection techniques, the intrusion detection technique based on illicit event detection is not able to cope with attacks with unregistered illicit data, and the intrusion detection technique based on abnormality detection has not been supported by an established method of detecting abnormality by using a CAN signal within the vehicle. Then, even in the system described in JP 2003-264595 A, various component elements, including the decoy network B40, the luring portion B3, the filtering process portion B5, the intrusion detection portion B4, etc., are needed in order to inhibit illicit data from being input to the internal network B30, and therefore a complicated construction is inevitable in order to maintain security. That is, the feasibility of mounting this system in a vehicle is quite low.

### SUMMARY OF THE INVENTION

The invention has been accomplished in view of the foregoing circumstances. An object of the invention is to provide a vehicle network monitoring apparatus that is able to maintain high level of security of a vehicle network through monitoring data input to the vehicle network, without a need to have a complicated construction in particular.

Hereinafter, means for solving the foregoing task and operation and effects of the means will be described. In accordance with a first aspect of the invention, a vehicle network monitoring method that monitors communication data transmitted and received in a vehicle network where data is communicated between a plurality of onboard control apparatuses includes a detection process of detecting illicit data through monitoring a communication format of data predetermined in order to operate a communication protocol used in the vehicle network.

According to the first aspect of the invention, it can be detected that illicit data is being transmitted in the vehicle network, merely by monitoring the communication format of data transmitted to the vehicle network.

In the first aspect of the invention, the vehicle network monitoring method may, further include an inhibition process of inhibiting, when the illicit data is detected, illicit actions of the plurality of onboard control apparatuses resulting from entry of the illicit data into the vehicle network.

According to the foregoing construction, even if illicit data enters the vehicle network, the above-described inhibition process is executed so that despite receiving the illicit data, the onboard control apparatuses are inhibited from performing an illicit action.

In the vehicle network monitoring method in accordance with the foregoing aspect, in the inhibition process, at least one of an alarm process of transmitting alarm information to the plurality of onboard control apparatuses and a prohibition process of transmitting, to a gateway provided in the vehicle network so as to relay the data, prohibition information that prohibits the gateway from routing the illicit data may be executed.

According to the foregoing construction, as one of the inhibition processes performed by the monitoring portion, the process of transmitting the alarm information to the plurality of onboard control apparatuses is executed.

In the first aspect, the vehicle network monitoring method may further include an action prohibition process in which the plurality of onboard control apparatuses prohibit an action caused by the detected illicit data when the onboard control apparatuses receive the alarm information, and a change process in which the gateway changes a routing table that the gateway has, when the gateway receives the prohibition information.

Therefore, even if illicit data is transmitted into the vehicle network, the illicit data can be inhibited from affecting the actions of the onboard control apparatuses.

In the first aspect, the alarm process may include: a conversion process of creating the alarm information as a message code and transmitting a converted code to the plurality of onboard control apparatuses, the converted code being obtained by subjecting a created message code to a computation process that uses a computation code that is possessed beforehand, and a reconstitute process in which the plurality of onboard control apparatuses reconstitute a received converted code into the message code by using the computation code that the onboard control apparatuses have.

According to the foregoing construction, the alarm information for alarming the onboard control apparatuses about entry of illicit data is concealed by the computation code possessed by only the monitoring portion and the onboard control apparatuses, that is, only the authentic apparatuses. Then, when the concealed alarm information (converted code) is transmitted to the onboard control apparatuses, each of the onboard control apparatuses is able to reconstitute the converted code to an interpretable state by using the computation code that the onboard control apparatus itself possesses.

In the vehicle network monitoring method in accordance with the first aspect, in the detection process, the detected data may be determined as being illicit data when data of a communication format different from a predetermined communication format that is predetermined beforehand as a communication format that is used during normality.

Due to the foregoing construction, it is possible to detect transmission of illicit data into the vehicle network even if the illicit data is unknown data.

In the vehicle network monitoring method in accordance with the first aspect, in the detection process, cycle time of the data transmitted in the vehicle network may be monitored as the communication format of the data, and the illicit data may be detected through detection of abnormality of the cycle time.

Due to the foregoing construction, it becomes possible to more easily and precisely detect illicit data that has entered the vehicle network.

In the vehicle network monitoring method in accordance with the first aspect, in the detection process, the number of times of transmission of a reply signal that is transmitted from the onboard control apparatuses as a reply to a trigger signal that requests the onboard control apparatuses to provide the data may be monitored as the communication format of the data, and when the same reply signal is received a plurality of times during a period from reception of the trigger signal to the next reception of the trigger signal, a portion of the reply signal received the plurality of times may be detected as being the illicit data.

Due to the foregoing construction, it becomes possible to more easily and precisely detect illicit data.

In the vehicle network monitoring method in accordance with the first aspect, in the detection process, the number of times of transmission of an error frame that the onboard control apparatuses transmit based on detection of an error may be monitored as the communication format of the data, and the transmission of the illicit data in the vehicle network may be detected when the number of times of transmission of the error frame monitored exceeds a prescribed number of times of transmission.

Due to the foregoing construction, it becomes possible to detect whether illicit data is being transmitted in the vehicle network merely by monitoring the number of times of transmission of the error frame that is transmitted from the onboard control apparatuses.

In the vehicle network monitoring method in accordance with the first aspect, in the detection process, transition to an off-the-bus state in which it is impossible for the onboard control apparatuses to transmit and receive the data may be detected, and transmission of the illicit data in the vehicle network may be detected based on detection of the off-the-bus state.

In the controller area network (CAN), each of the onboard control apparatuses is equipped with the off-the-bus function in which when the onboard control apparatus detects that the onboard control apparatus itself is performing an illicit action, the onboard control apparatus stops communication with the other onboard control apparatuses in order to inhibit the illicit action from affecting the other onboard control apparatuses. Therefore, when an onboard control apparatus turns into the off-the-bus state, it is highly possible that the onboard control apparatus is performing an illicit action due to reception of illicit data.

According to the foregoing construction, transmission of illicit data to the vehicle network is detected on the basis of transition of an onboard control apparatus to the off-the-bus state. Therefore, the monitoring portion is able to detect not only that an onboard control apparatus has transitioned to the off-the-bus state and the communication with that onboard control apparatus is impossible, but also that illicit data is being transmitted in the vehicle network. Thus, the monitoring portion is able to detect whether illicit data is being transmitted in the vehicle network, merely by monitoring the communication state of each of the onboard control apparatuses.

In accordance with a second aspect of the invention, a vehicle network monitoring apparatus that is connected to a vehicle network in which data is communicated between a plurality of onboard control apparatuses, and that monitors communication data transmitted and received in the vehicle network, the vehicle network monitoring apparatus includes a monitoring portion configured to detect illicit data through monitoring a data communication format predetermined in order to operate a communication protocol that is used in the vehicle network.

According to the second aspect of the invention, it can be detected that illicit data is being transmitted in the vehicle network, merely by monitoring the communication format of data transmitted in the vehicle network.

In the vehicle network monitoring apparatus in accordance with the second aspect, an onboard control apparatus configured to monitor the vehicle network may include the monitoring portion and may be provided in the vehicle network.

According to the second aspect of the invention, it can be detected that illicit data is being transmitted in the vehicle network, merely by monitoring the communication format of data transmitted in the vehicle network.

In the vehicle network monitoring apparatus in accordance with the second aspect, the vehicle network may include a network in which communication lines that constitute the vehicle network are connected to one gateway in a concentrated fashion, and the monitoring portion may be provided in the gateway to which the communication lines are connected in the concentrated fashion.

Due to the foregoing construction, security of the entire vehicle network can be collectively managed by one monitoring portion, so that good security of the vehicle network can be maintained while a simpler structure is adopted.

In the vehicle network monitoring apparatus in accordance with the second aspect, the vehicle network may include a control-system network to which an onboard control apparatus of a drive-control system which controls a vehicle drive system mounted in a vehicle is connected, and the monitoring portion may detect the illicit data transmitted to the control-system network.

According to the foregoing construction, it becomes possible to secure the security of the control-system network while employing a minimum construction.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram showing a general construction of a vehicle network to which an embodiment of a vehicle network monitoring apparatus in accordance with the invention id applied;

FIG. 2A is a time chart showing an example of a transmission cycle for an authentic data frame in a manner of detecting illicit data;

FIG. 2B is a time chart showing an example of a transmission cycle for an illicit data frame in the detection manner for illicit data;

FIG. 3A is a time chart showing an example of a transmission manner for a manner of transmitting a reply signal in response to a trigger signal during normality in the detection manner for illicit data;

FIG. 3B is a time chart showing an example of the transmission manner for the reply signal in response to the trigger signal at the time of occurrence of abnormality in the detection manner for illicit data;

FIG. 4A is a time chart showing an example of a transmission manner for an error frame during normality in the detection manner for illicit data;

FIG. 4B is a time chart showing an example of an error frame at the time of occurrence of abnormality in the detection manner for illicit data;

FIG. 5A is a time chart showing an example of a bus level that changes on the basis of the data that an authentic onboard control apparatus transmits, in the detection manner for the change;

FIG. 5B is a time chart showing an example of the data that an illicit control apparatus in the disguise of an authentic onboard control apparatus, in the detection manner for illicit data;

FIG. 6A is a block diagram showing an example of a manner in which alarm information is transmitted by a monitoring-purpose onboard control apparatus;

FIG. 6B shows an example of a data structure of alarm information transmitted from a monitoring-purpose onboard control apparatus;

FIG. 7 is a flowchart showing examples of a process of monitoring illicit data and a process of inhibiting illicit data which are performed by a monitoring-purpose onboard control apparatus;

FIG. 8 is a sequence diagram showing an example of operation of a vehicle network monitoring apparatus in this embodiment;

FIG. 9 is a block diagram showing a general construction of a vehicle network to which a vehicle network monitoring apparatus in accordance with another embodiment of the invention is applied;

FIG. 10 is a block diagram showing a general construction of a vehicle network to which a vehicle network monitoring apparatus in accordance with still another embodiment of the invention is applied; and

FIG. 11 is a block diagram showing a general construction of a network to which a related-art luring apparatus is applied.

### DETAILED DESCRIPTION OF EMBODIMENTS

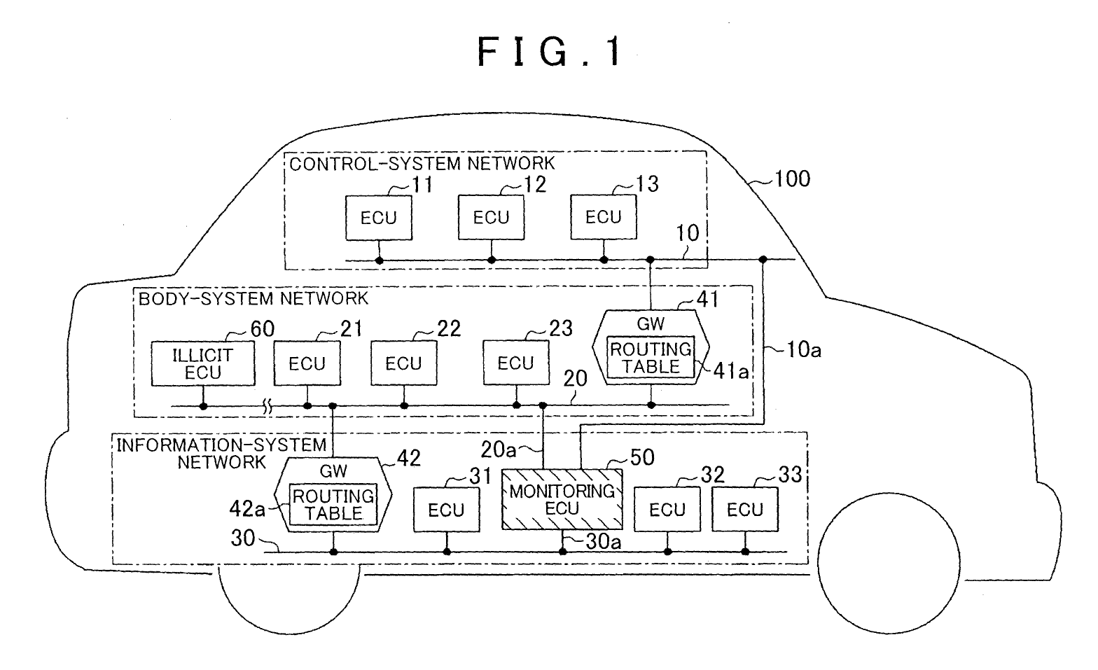

An embodiment of the vehicle network monitoring apparatus of the invention will be described with reference to FIGS. 1 to 8. Incidentally, a vehicle network monitoring apparatus of this embodiment monitors a controller area network (CAN) mounted in a vehicle as a vehicle network, through monitoring data transmitted to the control area network. Furthermore, in the vehicle network constructed of the CAN, data communication according to the communication protocol of the CAN is carried out.

As shown in FIG. 1, a vehicle 100 to which the vehicle network monitoring apparatus of the embodiment is applied is equipped with onboard control apparatuses (ECUs) 11 to 13 that electronically control various vehicle-drive-system appliances, including an engine, a brake, a steering device, etc. The onboard control apparatuses 11 to 13 are connected to a communication line 10 that constitutes a CAN bus, so as to construct a control-system network.

Furthermore, the vehicle 100 is also equipped with onboard control apparatuses 21 to 23 that control appliances of a body system, including an air-conditioner and meters that display various states of the vehicle 100 among other appliances. The onboard control apparatuses 21 to 23 are connected to a communication line 20 so as to constitute a body-system network.

Furthermore, the vehicle 100 is also equipped with onboard control apparatuses 31 to 33 of various information systems represented by a car navigation system that performs, for example, route guidance from the present location to a destination. The onboard control apparatuses 31 to 33 are connected to a communication line 30 so as to constitute an information-system network.

Furthermore, a gateway 41 that relays data communication between networks is connected between the communication line 10 that constitutes the control-system network and the communication line 20 that constitutes the body-system network. Likewise, a gateway 42 that relays data communication between networks is connected between the communication line 20 that constitutes the body-system network and the communication line 30 that constitutes the information-system network. The gateways 41 and 42 have routing tables 41a and 42a, respectively, in which destinations of data relayed are registered beforehand. Then, via the gateways 41 and 42, data communication is performed between the onboard control apparatuses 11 to 13, 21 to 23 and 31 to 33 in accordance with a data communication format predetermined in order to operate the communication protocol of each of the networks. Furthermore, for example, in the aforementioned car navigation system, various displayed assistances for a driver of the vehicle 100 are carried out on the basis of information regarding operations of the vehicle that is acquired from various onboard control apparatuses, such as an engine control apparatus, a brake control apparatus, etc.

In this embodiment, a monitoring-purpose onboard control apparatus (monitoring ECU) 50 for monitoring data transmitted between the networks is provided between the networks. The monitoring-purpose onboard control apparatus 50 is connected to a communication line 10a that extends from the communication line 10, a communication line 20a that extends from the communication line 20, and a communication line 30a that extends from the communication line 30. Therefore, the monitoring-purpose onboard control apparatus 50 is able to monitor the status of the data communication that is performed via the communication lines 10 to 30. Furthermore, the monitoring-purpose onboard control apparatus 50 of the embodiment has an error counter that counts the error status, that is, numerically monitors the error status, of the onboard control apparatuses 11 to 13, 21 to 23 and 31 to 33 on the basis of a specific monitoring policy. The monitoring-purpose onboard control apparatus 50 of the embodiment also has an ID table in which ID codes pre-assigned to the onboard control apparatuses 11 to 13, 21 to 23 and 31 to 33 are registered. Furthermore, the monitoring-purpose onboard control apparatus 50 of the embodiment has a logging function of, for example, recording as log data the contents of data transmitted onto the networks.

Then, when data communication is performed between the onboard control apparatuses 11 to 13, 21 to 23 and 31 to 33, the monitoring-purpose onboard control apparatus 50 monitors whether the data communication on one of the networks conforms to the communication format prescribed beforehand for that network. Generally, with regard to the vehicle network, the communication formats that can be assumed as communication formats of data transmission that can possibly occur on the vehicle network are prescribed. Therefore, if data of a communication format that is different from any one of the prescribed communication formats is transmitted to the vehicle network, there is high probability of that data being illicit data that is normally not transmitted to the vehicle network. Therefore, when the monitoring-purpose onboard control apparatus 50, on the basis of results of such monitoring, detects that data of a communication format different from any one of prescribed data communication formats is being transmitted in any one of the networks of the vehicle network, the monitoring-purpose onboard control apparatus 50 detects that illicit data that is essentially not transmitted in the vehicle network is being transmitted in the network. Specifically, the monitoring-purpose onboard control apparatus 50 detects that, for example, an illicit control apparatus (illicit ECU) 60 that has been illicitly connected to the communication line 20 is transmitting illicit data that is different in communication format from authentic data that is transmitted by the onboard control apparatuses 11 to 13, 21 to 23 and 31 to 33.

Incidentally, the illicit data that the illicit control apparatus 60 transmits is, for example, data that causes the onboard control apparatuses 11 to 13, 21 to 23 and 31 to 33 to perform an illicit action by rewriting a program incorporated in any one of the onboard control apparatuses 11 to 13, 21 to 23 and 31 to 33. Then, when a program of the onboard control apparatuses 11 to 13, 21 to 23 and 31 to 33 is rewritten, the onboard control apparatuses 11 to 13, 21 to 23 and 31 to 33 transmit data of a communication format (strange communication format) that is different from any one of the aforementioned prescribed communication formats. Therefore, the monitoring-purpose onboard control apparatus 50, when having received data of such a strange communication format from any one of the onboard control apparatuses 11 to 13, 21 to 23 and 31 to 33, detects that illicit data is being transmitted in the network that the monitoring-purpose onboard control apparatus 50 monitors. Incidentally, the illicit data that the illicit control apparatus 60 transmits include, for example, disguise data that resembles authentic data transmitted by the onboard control apparatuses 11 to 13, 21 to 23 and 31 to 33.

Then, upon detecting illicit data, the monitoring-purpose onboard control apparatus 50 of the embodiment executes an inhibition process of inhibiting the onboard control apparatuses 11 to 13, 21 to 23 and 31 to 33 from performing an illicit action as a result of the entry of the illicit data into the network. The monitoring-purpose onboard control apparatus 50 of the embodiment performs as inhibition processes a process of transmitting alarm information to the onboard control apparatuses 11 to 13, 21 to 23 and 31 to 33, and a process of transmitting to the gateways 41 and 42 prohibition information that prohibits the gateway 41 or 42 from routing illicit data.

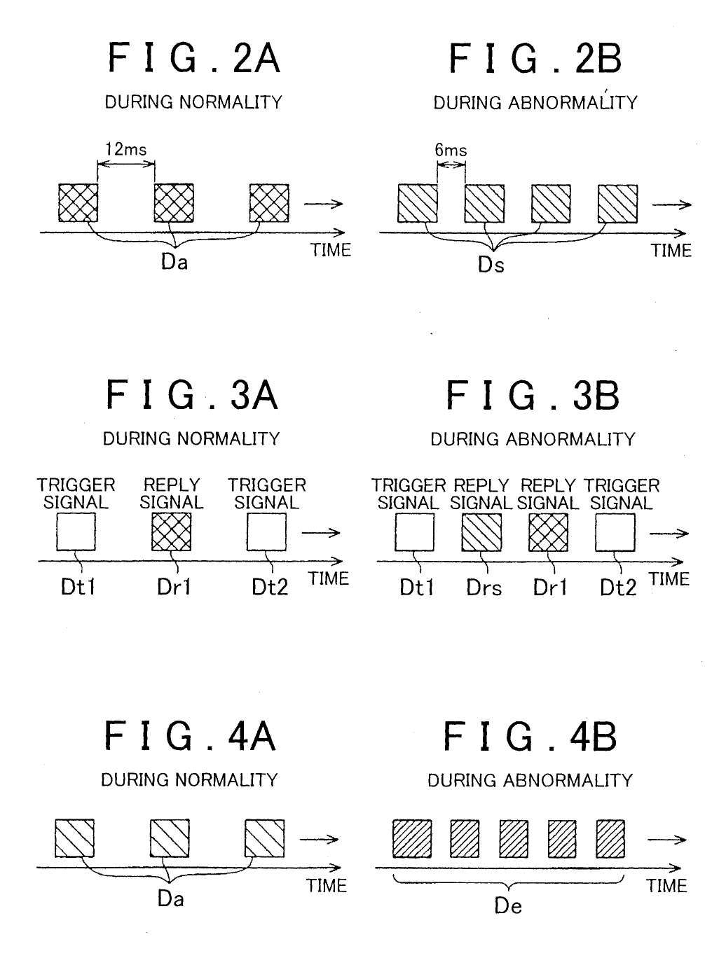

Next, a manner in which the monitoring-purpose onboard control apparatus 50 of the embodiment detects illicit data will be described with reference to FIGS. 2A to 5B. FIGS. 2A to 5B show manners of the monitoring performed on the basis of the monitoring policy that the monitoring-purpose onboard control apparatus 50 has:

As shown in FIG. 2A, each of the onboard control apparatuses 11 to 13, 21 to 23 and 31 to 33, when transmitting data, transmits a data frame Da in which communication data is divided in a cycle of, for example, a minimum of about 12 ms, in accordance with the aforementioned prescribed communication format. Incidentally, the data frame Da is provided with an ID code that is an identifier that shows data content or a transmission node. Furthermore, the ID codes determine the priority order in communication adjustment. When data frames of different ID codes are simultaneously transmitted onto the network, the data frame whose ID code is smaller in value is transmitted with priority over the other data frame.

On another hand, as shown in FIG. 2B, the control apparatus 60 that is attached in the network afterwards is unable to grasp the prescribed communication formats, and transmits an illicit data frame Ds on the basis of a cycle time of 6 ms that is different from the cycle time of the prescribed communication formats. Furthermore, for example, if a program pre-installed in any one of the onboard control apparatuses 11 to 13, 21 to 23 and 31 to 33 is rewritten by illicit data transmitted from the illicit control apparatus 60, that onboard control apparatus 11 to 13, 21 to 23 and 31 to 33 transmits an illicit data frame Ds on the basis of the cycle time of about 6 ins that is different from the cycle time of the prescribed communication formats.

Since the cycle time of the transmission frame data that constitutes the aforementioned communication data is prescribed, the data transmitted onto the vehicle network in a cycle time that is different from the prescribed cycle time is highly likely to be data transmitted by an illicit control apparatus or the like that is not able to grasp or know the prescriptions set within the vehicle network. Therefore, if a data frame whose cycle time is less than the prescribed cycle time of about 12 ms is transmitted onto the network that the monitoring-purpose onboard control apparatus 50 of the embodiment monitors, the monitoring-purpose onboard control apparatus 50 detects that illicit data is being transmitted on the network. Furthermore, the monitoring-purpose onboard control apparatus 50 specifically determines that the transmission source of the illicit data is the illicit control apparatus 60, for example, on the basis of the ID code assigned to the illicit data (illicit data frame Ds).

Furthermore, as shown in FIG. 3A, each of the onboard control apparatuses 11 to 13, 21 to 23 and 31 to 33, at the time of communication of various data, transmits a first data frame Dt1 that shows a trigger signal that requests data that the onboard control apparatus needs. In turn, the onboard control apparatus that has received the data frame Dt transmits a data frame Dr1 that shows the requested data as a reply signal that responds to the trigger signal. In the aforementioned prescribed communication format, the trigger signal and the reply signal as mentioned above are alternately transmitted on to the network. Therefore, on the network, data frames are transmitted in a manner of the first data frame Dt1, a data frame Dr1 that responds to the first data frame Dt1, the second data frame Dt2 . . . .

On another hand, as shown in FIG. 3B, the control apparatus 60 attached to the network afterwards transmits a data frame Drs in response to the first data frame Dt1, although the control apparatus 60 is not requested to transmit data. Therefore, once the first data frame Dt1 is transmitted, the illicit data frame Drs and the authentic data frame Dr1 are transmitted onto the network. As a result, one trigger signal is responded to by a plurality of reply signals.

In the case where an illicit control apparatus that transmits illicit data is allowed to access the vehicle network, it is assumed that the illicit control apparatus will reply to the trigger signal. In that case, since the authentic onboard control apparatuses and the illicit control apparatus reply to the trigger signal, a plurality of reply signals are transmitted on the vehicle network in response to one trigger signal. Therefore, when a plurality of reply signal have been transmitted in such a manner that the signals seem to be in response to a single trigger signal (first data frame Dt1), the monitoring-purpose onboard control apparatus 50 of the embodiment detects that at least one of the reply signals is a signal transmitted from the illicit control apparatus 60.

Furthermore, as shown in FIG. 4A, each of the onboard control apparatuses 11 to 13, 21 to 23 and 31 to 33 is provided with, for example, a function of transmitting an error frame De when the onboard control apparatus detects that the data frame transmitted by the onboard control apparatus has collided with the data transmitted by another one of the onboard control apparatuses. Usually, the number of times that the error frame De is transmitted when the onboard control apparatuses 11 to 13, 21 to 23 and 31 to 33 are normally operating tends to be, for example, less than or equal to about 150 times. Therefore, when error frames De are transmitted at a frequency that is higher than a usually assumed frequency as shown in FIG. 4B, it is highly likely that illicit data has been transmitted onto the network or that an onboard control apparatus whose program has been re-written by illicit data has caused another onboard control apparatus to transmit an error frame De. Furthermore, when the error frame De are transmitted at a higher frequency than usually assumed, it is highly likely that the error frames De are data frames transmitted by the illicit control apparatus 60.

Therefore, when the number of times of transmission of the error frame De exceeds a number of times of the transmission that can be usually assumed, the monitoring-purpose onboard control apparatus 50 of the embodiment detects that those error frames De have resulted from the presence of illicit data.

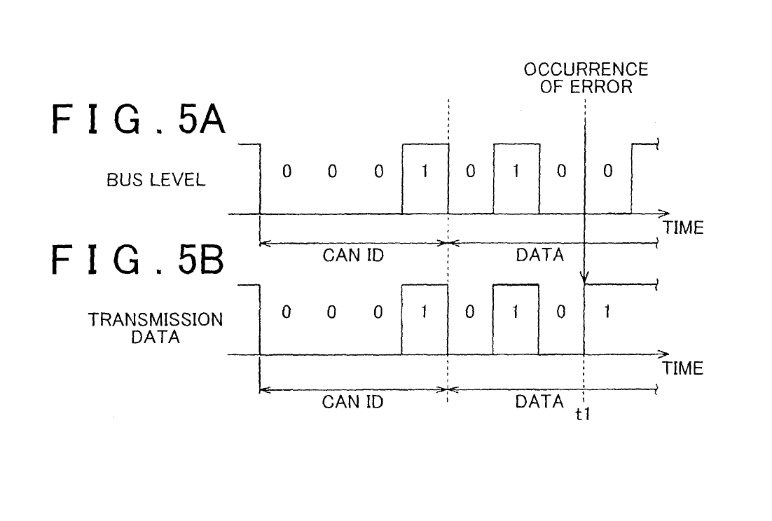

It is to be noted herein that, as shown in FIG. 5A, the onboard control apparatuses 11 to 13, 21 to 23 and 31 to 33, at the time of data communication based on the specifications of the CAN, perform the data communication by changing the bus level that is the electric potential of the communication lines 10 to 30 to “0” and “1”. Furthermore, each of the onboard control apparatuses 11 to 13, 21 to 23 and 31 to 33 is provided with a function of monitoring whether the data transmitted by the onboard control apparatus is being transmitted on the network. Due to this function, each of the onboard control apparatuses 11 to 13, 21 to 23 and 31 to 33 monitors whether the data transmitted by the onboard control apparatus itself, that is, the bus level transmitted, equals the bus level of the communication lines 10 to 30.

It is assumed that as shown in FIG. 5B, the illicit control apparatus 60 is disguised as the onboard control apparatus 11, and transmits data approximate to the data that the onboard control apparatus 11 transmits. Furthermore, it is assumed that at the timing t1; a difference between the bus level specified by the onboard control apparatus 11 and the bus level of each of the communication lines 10 to 30 occurs as the data that the onboard control apparatus 11 has transmitted and the data that the illicit control apparatus 60 has transmitted are different.

Then if the onboard control apparatus 11 recognizes the occurrence of a bit error, the onboard control apparatus 11, for example, transmits to the monitoring-purpose onboard control apparatus 50 error information that shows that a data transmission error has occurred. The monitoring-purpose onboard control apparatus 50, upon receiving the error information, adds, for example, “8”, to an error counter that the monitoring-purpose onboard control apparatus 50 itself manages. Conversely, if the monitoring-purpose onboard control apparatus 50 detects that data transmission has been performed successfully, the monitoring-purpose onboard control apparatus 50 subtracts “3” from the count value of the error counter. Incidentally, the error counter performs the counting, for example, separately for each one of the onboard control apparatuses 11 to 13, 21 to 23 and 31 to 33.

Then, when the count value of the error counter of one of the onboard control apparatuses 11 to 13, 21 to 23 and 31 to 33 that is increased or decreased as described above exceeds, for example, “255”, that onboard control apparatus determines that abnormality has occurred, and stops the data communication with the other onboard control apparatuses via the communication lines 10 to 30, that is, transitions to a so-called “off-the-buss state”. That is, when an onboard control apparatus enters the off-the-buss state, there is possibility that the onboard control apparatus is performing an illicit action on the basis of reception of illicit data.

Therefore, the monitoring-purpose onboard control apparatus 50 of the embodiment, upon detecting that any one of the onboard control apparatuses 11 to 13, 21 to 23 and 31 to 33 has transitioned to the “off-the-bus state”, detects that the illicit control apparatus 60 disguised as that onboard control apparatus is transmitting data onto the network.

Incidentally, by performing detection of illicit data through the use of a combination of the detection techniques described above with reference to FIGS. 2A to 5B, it becomes possible to detect illicit data from a plurality of viewpoints. Thus, it becomes possible to monitor whether illicit data is being transmitted within the vehicle network, from a plurality of viewpoints, so that reliability of the vehicle network monitoring apparatus improves.

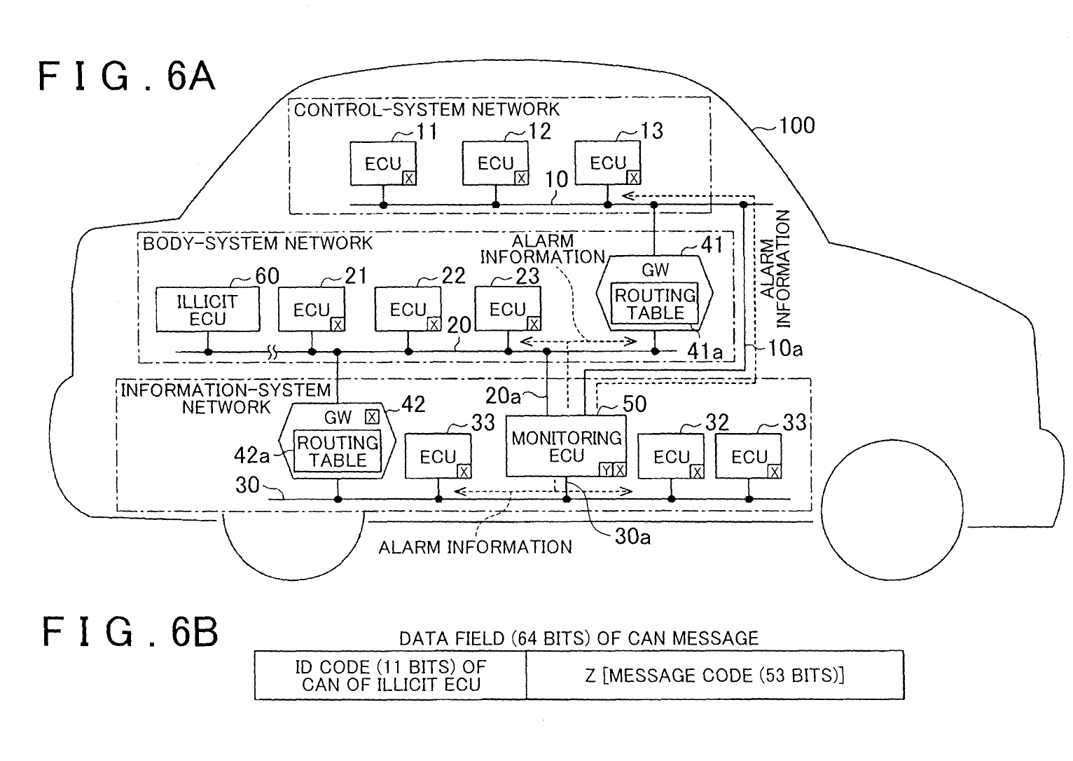

Next, the manner of the transmission of the alarm information performed by the monitoring-purpose onboard control apparatus 50 of the embodiment will be described with reference to FIGS. 6A and 6B. As shown in FIG. 6A, in this embodiment, the onboard control apparatuses 11 to 13, 21 to 23 and 31 to 33, the gateways 41 and 42 and the monitoring-purpose onboard control apparatus 50, which are all authentic components mounted in the vehicle 100, possess a specific computation code “X”, for example, of 53 bits. This computation code “X” is possessed for the time of diagnosis of the vehicle 100 performed before shipment from a factory or at a dealer. In contrast, the illicit control apparatus 60, which is attached to the vehicle 100 afterwards by an illicit measure, does not possess the computation code “X”.

Then, upon detecting illicit data on the basis of the above-described monitoring policy, the monitoring-purpose onboard control apparatus 50 of the embodiment identifies the illicit control apparatus 60, which is the source of transmission of the illicit data, on the basis of the ID code assigned to the data frame of the illicit data.

Next, the monitoring-purpose Onboard control apparatus 50 creates a message code “Y” that prohibits the onboard control apparatuses 11 to 13, 21 to 23 and 31 to 33 from using the illicit data that the identified illicit control apparatus 60 transmits. This message code “Y” is created as, for example, data of 53 bits. In this embodiment, the message code “Y” functions to prohibit the onboard control apparatuses 11 to 13, 21 to 23 and 31 to 33 from using the data that the illicit control apparatus 60 transmits, until a condition for discontinuing the inhibition process is satisfied. Incidentally, as the condition for discontinuing the inhibition process there are prescribed, for example, a condition that a predetermined time has elapsed, and a condition that the ignition key is on. Then, in this embodiment, the inhibition process is discontinued on condition that either one of the conditions is satisfied.

Then, the monitoring-purpose onboard control apparatus 50 creates a converted code “Z” by subjecting the computation code “X” that the monitoring-purpose onboard control apparatus 50 possess in advance and the message code “Y” to, for example, the XOR operation. The monitoring-purpose onboard control apparatus 50 then writes the created converted code “Z” and the ID code of the identified illicit control apparatus 60 which is expressed by, for example, 11 bits, into a data field of the data frame. Then, the monitoring-purpose onboard control apparatus 50 attaches its own ID code to the data frame, and transmits the data frame onto the network. Incidentally, the ID code attached to the data frame that shows the alarm information is an ID code that is smaller in value than the ID codes that the onboard control apparatuses 11 to 13, 21 to 23 and 31 to 33 attach to the data frame, so that data that shows the alarm information will be transmitted to the onboard control apparatuses 11 to 13, 21 to 23 and 31 to 33, with priority over the other data.

Each of the onboard control apparatuses 11 to 13, 21 to 23 and 31 to 33, upon receiving the data frame that the monitoring-purpose onboard control apparatus 50 transmits, reconstitutes the message code “Y” by subjecting the converted code “Z” written in the data field and the computation code “X” that the onboard control apparatus itself possesses to, for example, the XOR operation. Then, the onboard control apparatuses 11 to 13, 21 to 23 and 31 to 33, following the instruction of the message code “Y”, perform a process of prohibiting the use of the illicit data (illicit data frame) transmitted from the illicit control apparatus 60.

On the other hand, if the illicit control apparatus 60 acquires the data frame transmitted from the monitoring-purpose onboard control apparatus 50, the illicit control apparatus 60 is unable to decrypt or interpret the message code “Y” since the illicit control apparatus 60 does not possess the computation code “X”. Therefore, the illicit control apparatus 60 cannot recognize that its own presence has been detected. This reduces the number of incidents in which after the monitoring-purpose onboard control apparatus 50 transmits the alarm information (message code “Y”), the illicit control apparatus 60 recognizes that its own presence has been detected; and performs assumption of disguise or the like.

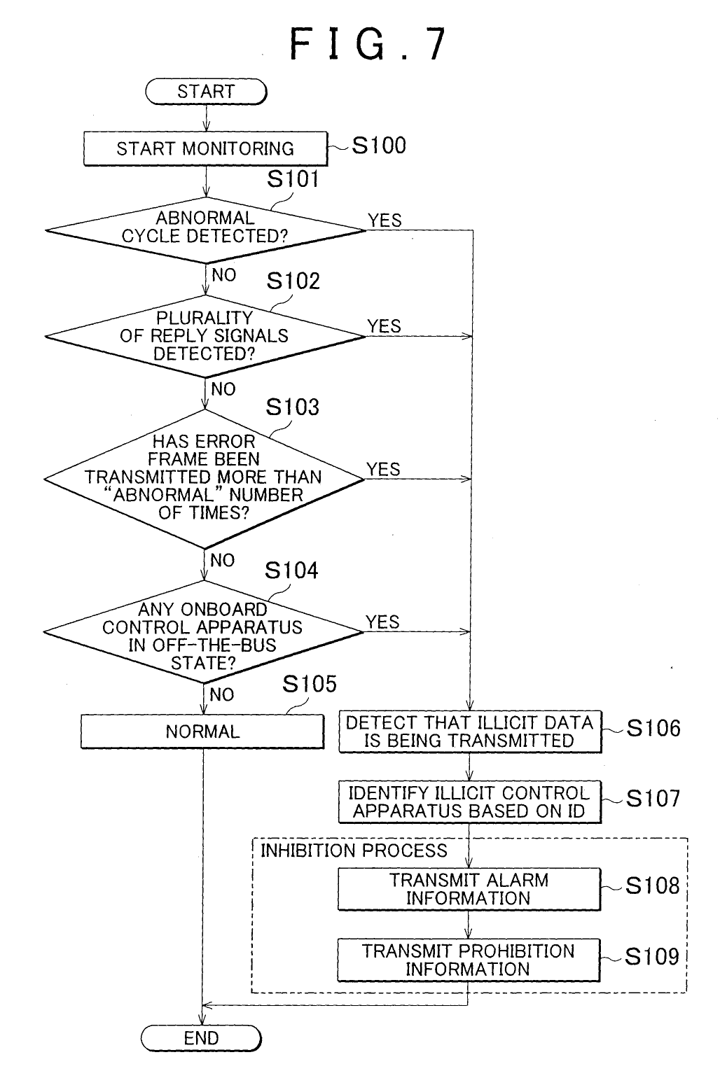

Next, a procedure of monitoring the network and a procedure of inhibiting illicit data which are performed by the monitoring-purpose onboard control apparatus 50 of the embodiment will be described with reference to FIG. 7. As shown in FIG. 7, for example, when the ignition key of the vehicle 100 is turned on, the monitoring-purpose onboard control apparatus 50 starts monitoring the network (step S100). Next, the monitoring-purpose onboard control apparatus 50 monitors whether illicit data is being transmitted on the network on the basis of the monitoring policy that the monitoring-purpose onboard control apparatus 50 itself possesses. Specifically, the monitoring-purpose onboard control apparatus 50 monitors whether the transmission cycle time of the data frame transmitted onto the network is less than a minimum cycle time (step S101). Besides, the monitoring-purpose onboard control apparatus 50 monitors whether a plurality of reply signals are being transmitted in response to one trigger signal (step S102). Furthermore, the monitoring-purpose onboard control apparatus 50 monitors whether the number of times that one of the onboard control apparatuses 11 to 13, 21 to 23 and 31 to 33 has transmitted the error frame has exceeded an “abnormal” number of times (e.g., 150 times) that serves as a criterion for detection of occurrence of abnormality (step S103). Furthermore, the monitoring-purpose onboard control apparatus 50 monitors whether among the onboard control apparatuses 11 to 13, 21 to 23 and 31 to 33 there is any onboard control apparatus that has transitioned to the off-the-bus state (step S104).

Then, if as a result of the monitoring, it is determined that there are none of the aforementioned abnormal states regarding the cycle time, the reply signal, the error frame and the onboard control apparatuses, the monitoring-purpose onboard control apparatus 50 determines that illicit data is not being transmitted in the network (step S105). That is, the monitoring-purpose onboard control apparatus 50 determines that the security of the network is maintained and the network and the onboard control apparatuses 11 to 13, 21 to 23 and 31 to 33 are functioning normally.

On the other hand, if as a result of the monitoring; it is determined that there exists any one of the abnormal states regarding the cycle time, the reply signal, the error frame and the onboard control apparatuses, the monitoring-purpose onboard control apparatus 50 determines that illicit data is being transmitted on the network (step S106). That is, on the basis of a result of the monitoring, the monitoring-purpose onboard control apparatus 50 detects that illicit data is being transmitted on the network and that the illicit control apparatus 60 has been incorporated in the network.

Then, after detecting illicit data being transmitted on the network, the monitoring-purpose onboard control apparatus 50 identifies the illicit control apparatus 60 on the basis of the ID code assigned to the illicit data (step S107).

Subsequently, the monitoring-purpose onboard control apparatus 50 performs a process of transmitting alarm information to the onboard control apparatuses 11 to 13, 21 to 23 and 31 to 33, as an inhibition process (step S108). Furthermore, the monitoring-purpose onboard control apparatus 50 performs a process of transmitting to the gateways 41 and 42 prohibition information for changing routing tables 41a and 42a that are possessed by the gateways 41 and 42 (step S109).

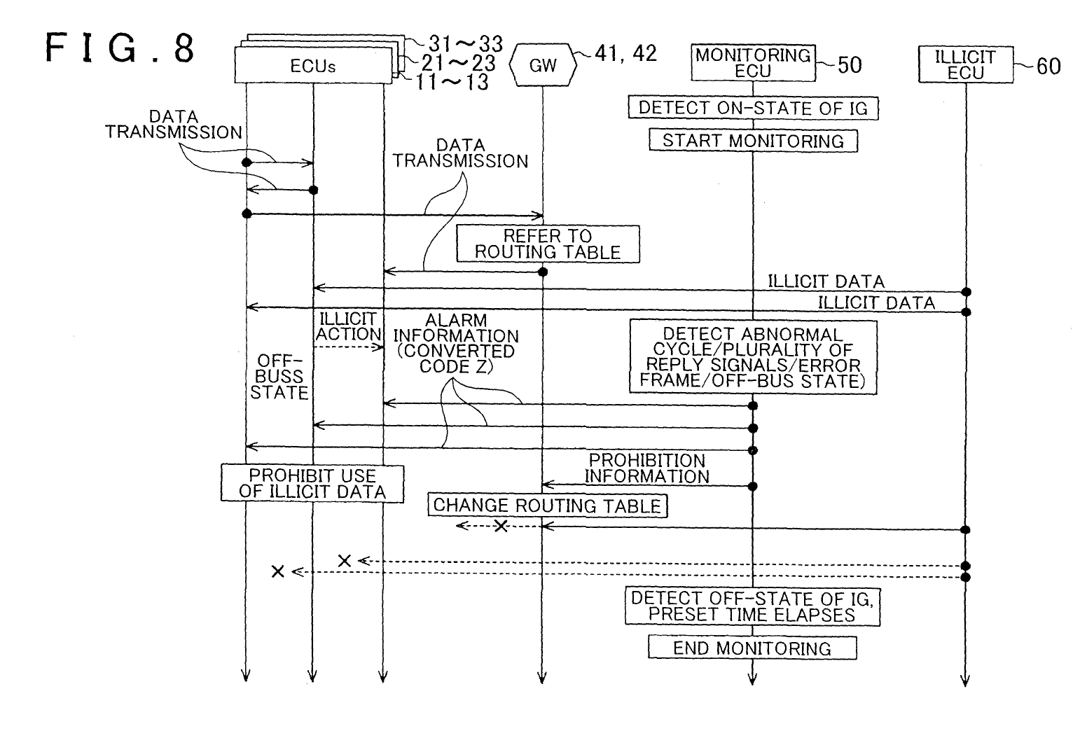

Hereinafter, operation of the vehicle network monitoring apparatus of the embodiment will be described with reference to FIG. 8. As shown in FIG. 8, for example, if an ignition key of the vehicle 100 is turned on, the monitoring-purpose onboard control apparatus 50 starts monitoring the network. Furthermore, in order to perform various vehicle controls, data is exchanged between the onboard control apparatuses 11 to 13, 21 to 23 and 31 to 33. Likewise, data exchange between the networks is performed via the gateways 41 and 42 that possess the routing tables 41a and 42a.

Let it assumed herein that the illicit control apparatus 60 that has been illicitly attached within the network or that makes illicit access from an external network has transmitted illicit data into the body-system network that has the communication line 20.

At this time, if the monitoring-purpose onboard control apparatus 50 detects; for example, that the data frame that constructs the illicit data that the illicit control apparatus 60 transmits has been transmitted in an abnormal cycle time that is less than the aforementioned prescribed minimum cycle time of about 12 ms, then the monitoring-purpose onboard control apparatus 50 detects that illicit data is being transmitted within the body-system network, that is, the illicit control apparatus 60 has illicitly entered the body-system network.

Then, the monitoring-purpose onboard control apparatus 50 transmits the converted code “Z” that indicates the alarm information to the onboard control apparatuses 11 to 13, 21 to 23 and 31 to 33. Upon receiving the converted code “Z”, the onboard control apparatuses 11 to 13, 21 to 23 and 31 to 33 reconstitute the converted code “Z” to the alarm information. Subsequently, on the basis of the reconstituted alarm information, the onboard control apparatuses 11 to 13, 21 to 23 and 31 to 33 perform a process of prohibiting the use of the illicit data transmitted from the illicit control apparatus 60. This inhibits an undesired event that one of the onboard control apparatuses 11 to 13, 21 to 23 and 31 to 33 uses the illicit data, resulting in the illicit rewriting of normal programs, data or the like installed beforehand in that onboard control apparatus.

Furthermore, the monitoring-purpose onboard control apparatus 50, after detecting illicit data, transmits the prohibition information to the gateways 41 and 42 to request the gateways 41 and 42 to change the routing tables 41a and 42a that the gateways 41 and 42 possess. Due to this, the routing tables 41a and 42a possessed by the gateways 41 and 42 are changed so as to prohibit the routing of the illicit data that would otherwise go through the gateways 41 and 42. As a result, the illicit data transmitted into the body-system network is inhibited from spreading into the control-system network or the information-system network via the gateways 41 and 42.

As described above, the vehicle network monitoring apparatus in accordance with the embodiment achieve the following effects. (1) Inside the vehicle network, the monitoring-purpose onboard control apparatus 50 that detects illicit data through monitoring the data communication format predetermined in order to operate the communication protocol used in the vehicle network is provided. The onboard control apparatuses connected to the vehicle network transmit and receive data in the communication format prescribed in the communication protocol of the vehicle network. Therefore, if data that does not follow the communication format has been transmitted to the vehicle network, it is highly possible that illicit data is being transmitted in the vehicle network or that one or more of the onboard control apparatuses are in abnormal state due to their reception of illicit data or the like. Therefore, merely by causing the monitoring-purpose onboard control apparatus 50 to monitor the communication format of data transmitted to the vehicle network, it is possible to detect transmission of illicit data in the vehicle network. This makes it possible to maintain high level of security of the vehicle network without requiring a complicated construction in particular.

(2) When the monitoring-purpose onboard control apparatus 50 detects illicit data, the monitoring-purpose onboard control apparatus 50 executes the inhibition process of inhibiting the onboard control apparatuses 11 to 13, 21 to 23 and 31 to 33 from performing illicit actions as a result of the entry of the illicit data into the vehicle network. Therefore, even if illicit data enters the vehicle network, the execution of the above-described inhibition process inhibits the onboard control apparatuses 11 to 13, 21 to 23 and 31 to 33 that have received the illicit data from performing an illicit action. Thus, even after illicit data has entered, it is possible to minimize the influence thereof and secure normal actions of the onboard control apparatuses 11 to 13, 21 to 23 and 31 to 33. Furthermore, even if the illicit control apparatus 60 that serves as a transmission source of illicit data is incorporated in the vehicle network, it is possible to inhibit illicit data transmitted from the illicit control apparatus 60 from affecting the onboard control apparatuses 11 to 13, 21 to 23 and 31 to 33 and the vehicle network without a need to physically detach the illicit control apparatus 60 from the vehicle network.

(3) As the inhibition process, the vehicle network monitoring apparatus in accordance with the embodiment performs the process of transmitting the alarm information to the onboard control apparatuses 11 to 13, 21 to 23 and 31 to 33 and the process of transmitting to the gateways 41 and 42 the prohibition information that prohibits the routing of the illicit data. Due to this; the onboard control apparatuses 11 to 13, 21 to 23 and 31 to 33, upon receiving the alarm information, can be caused to recognize the presence of illicit data, and can be caused to perform various operations that can inhibit the influence of the illicit data that is transmitted on the vehicle network. Furthermore, as a result, even if illicit data is about to go through the gateways 41 and 42, the gateways 41 and 42 prohibit the routing of the illicit data, so that the illicit data is not transmitted to the onboard control apparatuses 11 to 13, 21 to 23 and 31 to 33. Thus, illicit data is stopped part way through the gateways 41 and 42, so that spread of illicit data via the gateways 41 and 42 is inhibited.

(4) The onboard control apparatuses 11 to 13, 21 to 23 and 31 to 33, when having received the alarm information, are caused to perform the process of prohibiting actions based on the detected illicit data. Due to this, even if illicit data is transmitted into the vehicle network, the illicit data can be inhibited from affecting the actions of the onboard control apparatuses 11 to 13, 21 to 23 and 31 to 33. Furthermore, when illicit data is detected, the gateways 41 and 42 are caused to perform the process of changing the routing tables 41a and 42a that the gateways 41 and 42 possess. By changing the routing tables 41a and 42a, spread of the illicit data is inhibited, so that high level of security of the vehicle network that has the gateways 41 and 42 can be maintained.

(5) The onboard control apparatuses 11 to 13, 21 to 23 and 31 to 33 and the monitoring-purpose onboard control apparatus 50 are provided with a specific computation code “X” beforehand. Then, the monitoring-purpose onboard control apparatus 50 creates the alarm information as the message code “Y”. Furthermore, the monitoring-purpose onboard control apparatus 50 transmits to the onboard control apparatuses 11 to 13 and 21 to 23 the message code “Y” after converting it into the converted code “Z” through a computation process that employs the computation code “X”. Therefore, the illicit control apparatus 60 detects that its presence has been recognized by the onboard control apparatuses 11 to 13, 21 to 23 and 31 to 33 and the like, and therefore is inhibited from disguising itself as an authentic onboard control apparatus. Thus, once the presence of illicit data or of the control apparatus 60, which acts as a transmission source of illicit data, is detected, the stable monitoring of the detected illicit data and the control apparatuses is promoted.

(6) When the monitoring-purpose onboard control apparatus 50 detects data of a communication format different from the prescribed communication format that is prescribed beforehand as a communication format that is used during normality, the monitoring-purpose onboard control apparatus 50 specifically determines the detected data as being illicit data. Therefore, the monitoring-purpose onboard control apparatus 50 is able to detect illicit data merely by grasping communication formats that have already been known. Therefore, the monitoring-purpose onboard control apparatus 50 is able to detect transmission of illicit data into the vehicle network even if the illicit data is unknown data.

(7) The monitoring-purpose onboard control apparatus 50 monitors the cycle time of the data frame transmitted to the vehicle network as the data communication format, and detects illicit data on the basis of detection of abnormality about the cycle time. Therefore, the monitoring-purpose onboard control apparatus 50 is able to detect illicit data merely by monitoring the transmission cycle of data as a communication format of data. Therefore, it becomes possible to more easily and precisely detect illicit data that has entered the vehicle network.

(8) The monitoring-purpose onboard control apparatus 50 monitors, as a data communication form as mentioned above, the number of times of transmission of a reply signal that is transmitted to the onboard control apparatuses 11 to 13, 21 to 23 and 31 to 33 as a reply to the trigger signal. When the same reply signal is transmitted a plurality of times during the period from the reception of a trigger signal to the reception of the next trigger signal, a portion of the reply signal that has been received a plurality of times is detected as being illicit data. Therefore, the monitoring-purpose onboard control apparatus 50 is able to detect whether illicit data is being transmitted in the vehicle network, merely by counting the number times of transmission of the reply signal. Therefore, detection of illicit data can be performed more easily and precisely.

(9) The monitoring-purpose onboard control apparatus 50 monitors, as a communication format of data, the number of times of transmission of the error frame De that is transmitted by the onboard control apparatuses 11 to 13, 21 to 23 and 31 to 33, on the basis of detection of an error. Then, provided that the number of times of transmission of the error frame De exceeds a prescribed number of times of transmission, the monitoring-purpose onboard control apparatus 50 detects that illicit data is being transmitted in the vehicle network. Therefore, the monitoring-purpose onboard control apparatus 50 is able to detect whether illicit data is being transmitted in the vehicle network merely by monitoring the number of times of transmission of the error frame De that is transmitted from the onboard control apparatuses 11 to 13, 21 to 23 and 31 to 33. Furthermore, the number of times (e.g., 150 times) of transmission of the error frame De, which serves as an index for detection of illicit data, is set at a number that is less than the number of times of transmission (255 times) that is set as a criterion for the transition of the onboard control apparatus to the off-the-bus state. Therefore, the monitoring-purpose onboard control apparatus 50 is able to detect illicit data before any one of the onboard control apparatuses 11 to 13, 21 to 23 and 31 to 33 transitions to the off-the-bus state as a result of excessive transmission of the error frame De.

(10) When any one of the onboard control apparatuses 11 to 13, 21 to 23 and 31 to 33 has transitioned to the off-the-bus state, the monitoring-purpose onboard control apparatus 50 detects that illicit data is being transmitted in the vehicle network, through recognition of the off-the-bus state detected on that onboard control apparatus. Therefore, the monitoring-purpose onboard control apparatus 50 is able to detect not only that one of the onboard control apparatuses 11 to 13, 21 to 23 and 31 to 33 has transitioned to the off-the-bus state and the communication with that onboard control apparatus is impossible, but also that illicit data is being transmitted in the vehicle network. Thus, the monitoring-purpose onboard control apparatus 50 is able to detect whether illicit data is being transmitted in the vehicle network, merely by monitoring the communication state of each of the onboard control apparatuses 11 to 13, 21 to 23 and 31 to 33.

(11) The monitoring-purpose onboard control apparatus50 performs the monitoring on the basis of the cycle time of the data frame, the count of reply signals, the number of times of transmission of the error frame De and the off-the-bus state of the onboard control apparatuses 11 to 13, 21 to 23 and 31 to 33. Therefore, the monitoring-purpose onboard control apparatus 50 is able to monitor whether illicit data is being transmitted in the vehicle network from various viewpoints, so that the reliability of the vehicle network monitoring apparatus increases favorably.

(12) The monitoring portion is provided as the monitoring-purpose onboard control apparatus 50 in the vehicle network. Therefore, primarily, by causing a portion or the whole of one or more of the onboard control apparatus connected to the vehicle network to function as the monitoring-purpose onboard control apparatus 50, it is possible to maintain security of the vehicle network through the monitoring of the vehicle network. Therefore, it is not necessary to separately provide an apparatus for monitoring the vehicle network, but a highly versatile onboard control apparatus connected to the vehicle network can be used to realize the monitoring of the vehicle network.

Incidentally, the foregoing embodiments can also be carried out in the following forms.

In the foregoing embodiments, the alarm information is converted to the converted code “Z” by using the computation code “X”. Instead of this construction, all the data transmitted by the monitoring-purpose onboard control apparatus 50 and the onboard control apparatuses 11 to 13, 21 to 23 and 31 to 33 may be converted into the converted codes by using the computation code “X”. Then, if one of the onboard control apparatuses 11 to 13, 21 to 23 and 31 to 33, after receiving the converted code, successfully reconstitutes the converted code “Z” by using the computation code “X” that the onboard control apparatus has, it may be determined that the data that has been successfully reconstituted is authentic data that is transmitted from one of the monitoring-purpose onboard control apparatus 50 and the onboard control apparatuses 11 to 13, 21 to 23 and 31 to 33. Then, the monitoring-purpose onboard control apparatus 50 and the onboard control apparatuses 11 to 13, 21 to 23 and 31 to 33 may be permitted to use only the data that has been determined as being authentic data. Therefore, each of the monitoring-purpose onboard control apparatus 50 and the onboard control apparatuses 11 to 13, 21 to 23 and 31 to 33 can determine whether the data received is authentic data, with reference to whether the data can be reconstituted through the use of the computation code “X” that the control apparatus itself has.

The foregoing computation operation through the use of the computation code “X” is carried out according to the XOR operation However, this is not restrictive, but the alarm information may be encrypted by the monitoring-purpose onboard control apparatus 50 through the use of a common key, a secret key and the like that only the monitoring-purpose onboard control apparatus 50 and the authentic onboard control apparatuses 11 to 13, 21 to 23 and 31 to 33 possess beforehand. Then, the encrypted alarm information may be transmitted to the onboard control apparatuses 11 to 13, 21 to 23 and 31 to 33. With such a technique that uses a common key, a secret key, etc., it becomes possible to execute the inhibition process without allowing the illicit control apparatus 60 to recognize that its presence has been detected.

As a condition for discontinuing the inhibition process, the foregoing embodiments employ the condition that either one of the condition that a predetermined time has elapsed and the condition that the ignition key has been turned on is satisfied. However, this is not restrictive, but the inhibition process may also be inhibited on condition that a predetermined time has elapsed and the ignition key has been turned on. Furthermore, it suffices that the condition for discontinuing the inhibition process is a condition that makes an estimation that the transmission of illicit data has stopped or the like. For example, the condition for discontinuing the inhibition process may be a condition that a diagnosis of the vehicle 100 has ended, a condition that the onboard control apparatuses 11 to 13, 21 to 23 and 31 to 33 have been initialized, etc.

The illicit data to cope with in the foregoing embodiments is data transmitted from the illicit control apparatus 60 that has been illicitly attached to the body-system network. However, the illicit data may also be data that is illicitly transmitted into the vehicle network via illicit access from an external network. Thus, even if illicit data transmitted from an external network enters the vehicle network, it is possible to monitor the illicit data through the monitoring performed by the monitoring-purpose onboard control apparatus 50.

The monitoring-purpose onboard control apparatus 50 logs the data that the apparatus monitors in the foregoing embodiments. The log data recorded by the logging may also be used for definition of a new monitoring policy or traceability (tracking characteristic) of an attack made by the illicit control apparatus 60. At the time of defining a new monitoring policy there is performed, for example, update of an abnormal cycle time, update of the abnormal number of times of transmission of the error frame, etc.

As the monitoring portion, a single unit of the monitoring-purpose onboard control apparatus 50 is provided in the vehicle network. Instead of this, two or more monitoring-purpose onboard control apparatuses 50 may be provided within the vehicle network. In this construction, by providing monitoring-purpose onboard control apparatuses separately for each of the control-system network, the body-system network and the information-system network, it becomes possible for the dedicated monitoring onboard control apparatuses to individually perform the monitoring of the corresponding networks. Thus, even if a program or data of one of the monitoring-purpose onboard control apparatuses is rewritten by illicit data, the security level of the network can be kept in a suitable fashion by the other monitoring-purpose onboard control apparatuses. Therefore, fault tolerance related to the monitoring of the vehicle network is maintained.

The monitoring by the monitoring-purpose onboard control apparatus 50 is performed for all the networks that include the control-system network, the body-system network and the information-system network. However, instead of this, only the control-system network may be monitored by the monitoring-purpose onboard control apparatus 50. In this manner of monitoring, since the object to monitor is limited to the control-system network, which is high in the degree of importance in the control of the vehicle 100 (particularly high in the need to maintain security), the load of monitoring on the monitoring-purpose onboard control apparatus 50 is minimized. Furthermore, this makes it possible to direct the monitoring by the monitoring-purpose onboard control apparatus 50 to the control-system network, which is high in the degree of importance. Furthermore, the object of the monitoring performed by the monitoring-purpose onboard control apparatus 50 may be any one of the control-system network, the body-system network and the information-system network. In short, anything can be an object of the monitoring by the monitoring-purpose onboard control apparatus 50 as long as it is a portion or the whole of a vehicle network installed in the vehicle 100.

In the foregoing embodiments, the number of times of transmission of the error frame De, which serves as an index of detection of illicit data, is set to a number that is less than the number of times of transmission of the error frame De set as a criterion for transition of an onboard control apparatus to the off-the-bus state. Instead of this construction, for example, the number of times of transmission of the error frame De, which serves as an index of illicit data, may also be set to a number of times equal to the number of times of transmission of the error frame De set as a criterion for transition of the onboard control apparatus to the off-the-bus state.

In the embodiments, the monitoring by the monitoring-purpose onboard control apparatus 50 is performed on the basis of all of the followings: the cycle time of the data frame, the count of reply signals, the number of times of transmission of the error frame De, and the off-the-bus state of each of the onboard control apparatuses 11 to 13, 21 to 23 and 31 to 33. Instead of this, the monitoring of the monitoring-purpose onboard control apparatus 50 may also be performed on the basis of at least one of the cycle time of the data frame, the count of reply signals, the number of times of transmission of the error frame De, and the off-the-bus state of each of the onboard control apparatuses 11 to 13, 21 to 23 and 31 to 33. Still further, the monitoring by the onboard control apparatus 50 may also be performed with reference to whether data communication is being performed in accordance with the communication format prescribed beforehand in relation to operation of the protocol of this network.

In the forgoing embodiments, the alarm information is transmitted as the message code “Y” into which the large information is converted by using the computation code “X”. Instead of this, there may be provided a construction in which none of the onboard control apparatuses 11 to 13, 21 to 23 and 31 to 33 and the monitoring-purpose onboard control apparatus 50 are provided with a specific computation code “X”. In that construction, plain-text alarm information may be transmitted from the monitoring-purpose onboard control apparatus 50 to the onboard control apparatuses 11 to 13, 21 to 23 and 31 to 33, and the like. This construction reduces the computation load at the time of transmitting and receiving the alarm information. Incidentally, in this construction, too, the illicit data once detected is inhibited from being used by the onboard control apparatuses 11 to 13, 21 to 23 and 31 to 33.

In the foregoing embodiments, each of the onboard control apparatuses 11 to 13, 21 to 23 and 31 to 33, after receiving the alarm information, performs the process of prohibiting actions based on the detected illicit data. Furthermore, when illicit data is detected, the gateways 41 and 42 perform the process of changing the routing tables 41a and 42a that the gateways 41 and 42 possess. Instead of this, for example, the onboard control apparatuses 11 to 13, 21 to 23 and 31 to 33 and the gateways 41 and 42 may discard detected illicit data.

The inhibition process performed in the foregoing embodiment includes the process of transmitting the alarm information, and the process of prohibiting the gateways 41 and 42 from performing the routing of illicit data. Instead of this, there may also be adopted a construction in which either one of the process of transmitting the alarm information and the process of prohibiting the gateways 41 and 42 from performing the routing of illicit data is performed. Furthermore, the inhibition process may also be a process of sending a notification that illicit data has been transmitted in the network, to the driver, the management center in which the state of the vehicle 100 is managed, the dealer of the vehicle 100, etc.

In the foregoing embodiments, when the monitoring-purpose onboard control apparatus 50 detects illicit data, the monitoring-purpose onboard control apparatus 50 executes the inhibition process. Instead of this, the monitoring-purpose onboard control apparatus 50 may perform only the detection of illicit data. Furthermore, for example, there may be provided a construction in which the monitoring-purpose onboard control apparatus 50 performs only the detection of illicit data, and in which an apparatus provided separately from the monitoring-purpose onboard control apparatus 50 executes the inhibition process on the basis of results of the detection regarding illicit data.

In the foregoing embodiments, the monitoring-purpose onboard control apparatus 50 is provided with the error counter, the ID table or the logging function. However, this is not restrictive. It suffices that the monitoring-purpose onboard control apparatus 50 has a construction in which it is possible to monitor the communication format of data transmitted to the vehicle network. For example, the error counter, the ID table and the logging function can be omitted.

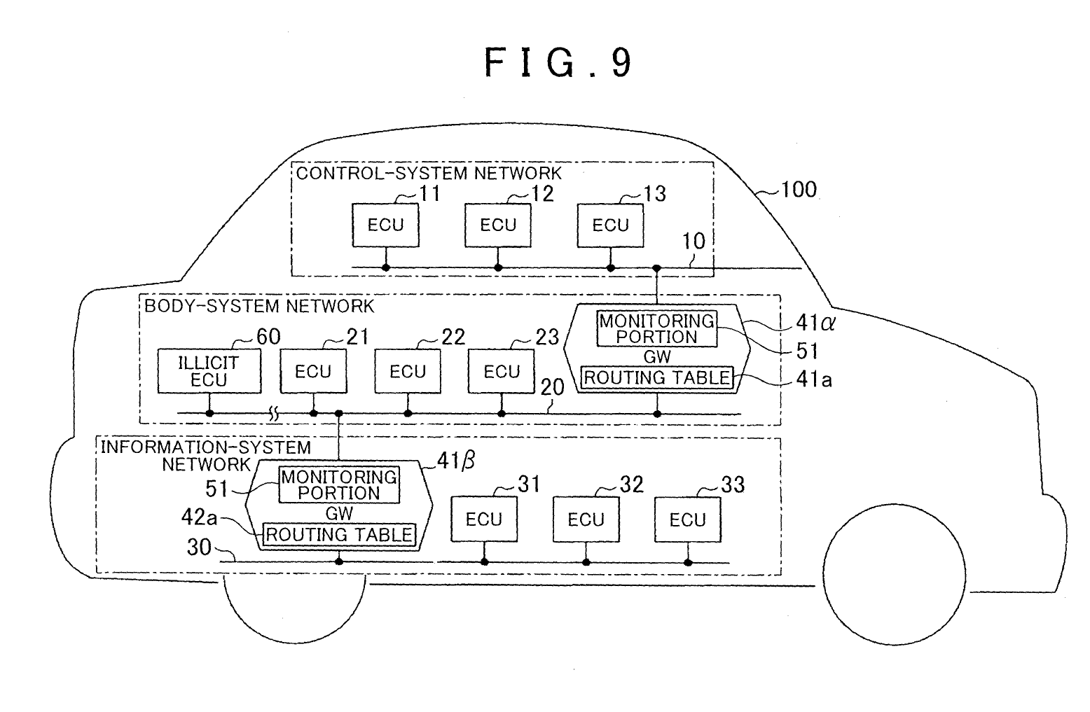

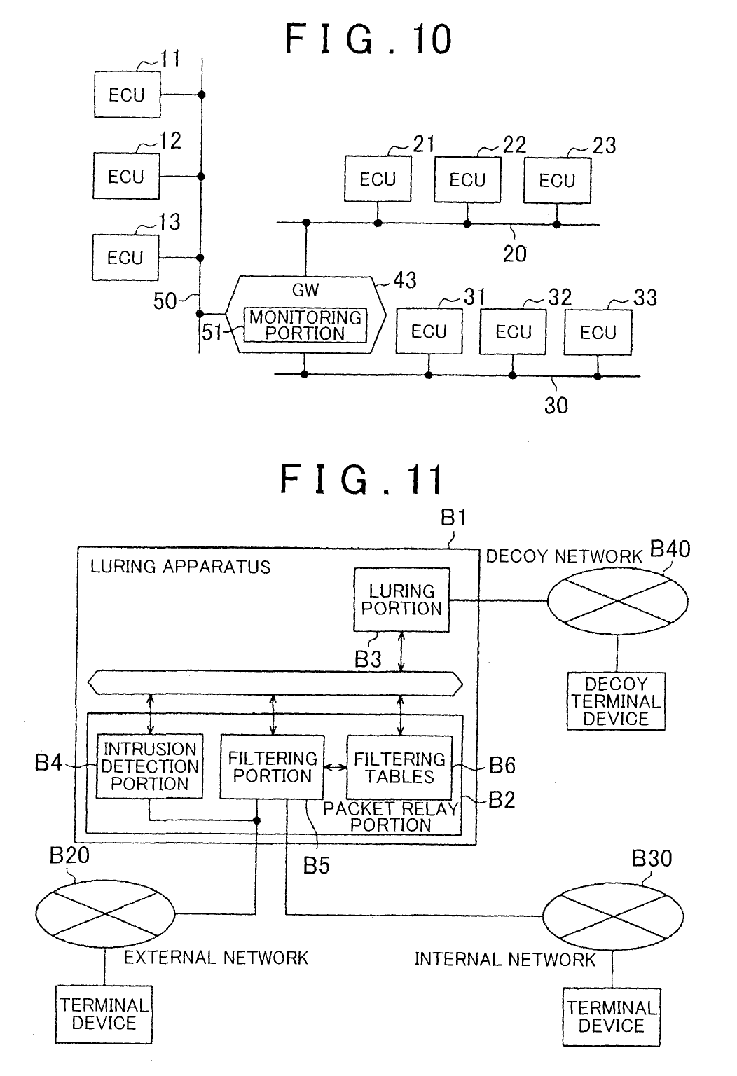

In the foregoing embodiments, the monitoring-purpose onboard control apparatus 50 is provided as an onboard control apparatus within the vehicle network. Instead of this, there may be provided, for example, a construction in which gateways 41a and 4213 are each provided with a monitoring portion 51 that has functions equivalent to the functions of the monitoring-purpose onboard control apparatus 50 as shown in FIG. 9 corresponding to FIG. 1 described above. In this construction, since each of the gateways 41α and 41β is constructed together with a corresponding one of the monitoring portions 51, an onboard control apparatus for monitoring illicit data is not necessary, and it becomes possible to further simplify the vehicle network monitoring apparatus. Furthermore, due to this, when either one of the monitoring portions 51 detects illicit data, a corresponding one of the gateways 41α and 41β that is provided with that monitoring portion 51 can be directly prohibited from performing the routing of the illicit data. Furthermore, there may also be provided a construction in which, for example, as shown in FIG. 10 corresponding to FIG. 1, all the communication lines 10 to 30 that constitute the networks respectively are connected to one gateway 43 in a concentrated fashion. Then, the gateway 43 may be provided with a monitoring portion 51. In this construction, since the gateway 43 to which the communication lines 10 to 30 are connected in a concentrated fashion is provided, the monitoring portion 51 is able to efficiently monitor the communication status of the entire vehicle network. Therefore, security of the entire vehicle network can be collectively managed by the single monitoring portion 51, so that good security of the vehicle network can be maintained while a simpler structure is adopted. Furthermore, there may also be provided a construction in which the monitoring portion 51 is provided in at least one of the onboard control apparatuses 11 to 13, 21 to 23 and 31 to 33. In this construction, too, the onboard control apparatus for monitoring illicit data becomes unnecessary, so that it becomes possible to further simplify the vehicle network monitoring apparatus. Furthermore, in this construction, each of the onboard control apparatuses 11 to 13, 21 to 23 and 31 to 33 that are responsible for controls of the vehicle 100 can independently secure the security of that apparatus. Further, it suffices that the monitoring portion is provided at such a position that the communication formant of data transmitted into the vehicle network can be monitored, and the manner of this installation can be appropriately changed.

In the foregoing embodiments, the foregoing vehicle network is CAN. However, this is not restrictive. It suffices that the vehicle network is one in which the data communication format is predetermined in order to operate the communication protocol. For example, the vehicle network may be FlexRay, IDB-1394, BEAN, LIN. AVC-LAN. MOST (registered trademarks), etc.

1-14. (canceled)

15. A vehicle network monitoring method that monitors communication data transmitted and received in a vehicle network where data is communicated between a plurality of onboard control apparatuses, the method comprising.
a detection process of detecting illicit data through monitoring a communication format of data predetermined in order to operate a communication protocol used in the vehicle network; and
an inhibition process of inhibiting, when the illicit data is detected, illicit actions of the plurality of onboard control apparatuses resulting from entry of the illicit data into the vehicle network, wherein
in the inhibition process, at least one of an alarm process of transmitting alarm information to the plurality of onboard control apparatuses and a prohibition process of transmitting, to a gateway provided in the vehicle network so as to relay the data, prohibition information that prohibits the gateway from routing the illicit data is executed.

16. The vehicle network monitoring method according to claim 15, further comprising
an action prohibition process in which the plurality of onboard control apparatuses prohibit an action caused by the illicit data when the onboard control apparatuses receive the alarm information; and
a change process in which the gateway changes a routing table that the gateway has, when the gateway receives the prohibition information.

17. The vehicle network monitoring method according to claim 15, wherein the alarm process includes:
a conversion process of creating the alarm information as a message code and transmitting a converted code to the plurality of onboard control apparatuses, the converted code being obtained by subjecting a created message code to a computation process that uses a computation code that is possessed beforehand; and
a reconstitute process in which the plurality of onboard control apparatuses reconstitute a received converted code into the message code by using the computation code that the onboard control apparatuses have.

18. The vehicle network monitoring method according to claim 15, wherein
in the detection process, the detected data is determined as being illicit data when data of a communication format different from a predetermined communication format that is predetermined beforehand as a communication format that is used during normality is detected.

19. The vehicle network monitoring method according to claim 15, wherein
in the detection process, cycle time of the data transmitted in the vehicle network is monitored as the communication format of the data, and the illicit data is detected through detection of abnormality of the cycle time.

20. The vehicle network monitoring method according to claim 15, wherein:
in the detection process, the number of times of transmission of a reply signal that is transmitted from the onboard control apparatuses as a reply to a trigger signal that requests the onboard control apparatuses to provide the data is monitored as the communication format of the data; and
when the same reply signal is received a plurality of times during a period from reception of the trigger signal to the next reception of the trigger signal, a portion of the reply signal received the plurality of times is detected as being the illicit data.

21. The vehicle network monitoring method according to claim 15, wherein
in the detection process, the number of times of transmission of an error frame that the onboard control apparatuses transmit based on detection of an error is monitored as the communication format of the data, and the transmission of the illicit data in the vehicle network is detected when the number of times of transmission of the error frame monitored exceeds a prescribed number of times of transmission.

22. The vehicle network monitoring method according to claim 15, wherein
in the detection process, transition to an off-the-bus state in which it is impossible for the onboard control apparatuses to transmit and receive the data is detected, and transmission of the illicit data in the vehicle network is detected based on detection of the off-the-bus state.

23. A vehicle network monitoring apparatus that is connected to a vehicle network in which data is communicated between a plurality of onboard control apparatuses, and that monitors communication data transmitted and received in the vehicle network, the vehicle network monitoring apparatus comprising;
a monitoring portion configured to detect illicit data through monitoring a data communication format predetermined in order to operate a communication protocol that is used in the vehicle network; and
a control apparatus configured to execute an inhibition process that inhibit illicit actions of the plurality of onboard control apparatuses resulting from entry of the illicit data into the vehicle network, when the illicit data is detected, wherein
in the inhibition process, the control apparatus executes at least one of an alarm process of transmitting alarm information to the plurality of onboard control apparatuses and a prohibition process of transmitting, to a gateway provided in the vehicle network so as to relay the data, prohibition information that prohibits the gateway from routing the illicit data.

24. The vehicle network monitoring apparatus according to claim 23, wherein
an onboard control apparatus configured to monitor the vehicle network includes the monitoring portion and is provided in the vehicle network.

25. The vehicle network monitoring apparatus according to claim 24, wherein:
the vehicle network includes a network in which communication lines that constitute the vehicle network are connected to one gateway in a concentrated fashion; and
the monitoring portion is provided in the gateway to which the communication lines are connected in the concentrated fashion.

26. The vehicle network monitoring apparatus according to claim 24, wherein:
the vehicle network includes a control-system network to which an onboard control apparatus of a drive-control system which controls a vehicle drive system mounted in a vehicle is connected; and
the monitoring portion detects the illicit data transmitted to the control-system network.
